(19) United States
(12) Patent Application Publication
(10) Pub. No.: US 2025/0057345 A1
(43) Pub. Date: Feb. 20, 2025

(54) Color Changing Sippy Cup

(71) Applicant: Elise Lambkin, Fort Lauderdale, FL (US)

(72) Inventor: Elise Lambkin, Fort Lauderdale, FL (US)

(21) Appl. No.: 18/235,059

(22) Filed: Aug. 17, 2023

(51) Int. Cl. A47G 19/22; G01K 11/12

(52) U.S. Cl. CPC A47G 19/2227; G01K 11/12; A47G 2019/225

(57) ABSTRACT

A sippy cup/bottle that changes color when the liquid inside is too hot or too cold. This helps parents ensure the liquid inside the container is at a safe temperature for their toddler or baby. The color-changing feature of the cup not only ensures safety but also provides an interactive element for the toddler which acts as a visual cue for the child to understand if their drink is ready to be sipped, adding an educational element to the drinking process.

PRIOR ART

While there are cups that change color with temperature, they primarily focus on cold temperatures, and the color change is more directed towards fun than function. However, the present subject matter views the color changing aspect of sippy cups or bottles as a safety feature.

### BACKGROUND OF THE INVENTION

Safety features such as temperature indicators have not been integrated into the traditional sippy cup design. While the field has evolved over time, with innovations like straw cups, 360-degree cups, and cups with handles that are easier for little hands to grip. However, there has been little focus on integrating smart features or temperature indicators into sippy cups.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present subject matter is a thermochromic material that changes color based on the temperature of the liquid inside the sippy cup or bottle which goes beyond just being a fun feature, it has a practical purpose in helping parents ensure that the drink is at a safe temperature for their toddler or baby. The color change is designed to be easy to interpret, such as turning a specific color if the drink is too hot or too cold. The present subject matter is designed to change color above 87 degrees Fahrenheit and change color below 57 degrees Fahrenheit. In some embodiments, the thermochromic material is Leuco Dye (5). In some embodiments, whether something is too hot or too cold may be indicated in a single sippy cup.

The color-changing feature of the cup not only ensures safety but also provides an interactive element for the toddler which acts as a visual cue for the child to understand if their drink is ready to be sipped, adding an educational element to the drinking process.

The present subject matter incorporates engaging designs that change with the temperature, making the cup not just a drinking vessel but an entertaining and educational item for the toddler.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

### BRIEF DESCRIPTION OF DRAWINGS

FIG. 1 shows a perspective view of the color changing baby bottle.

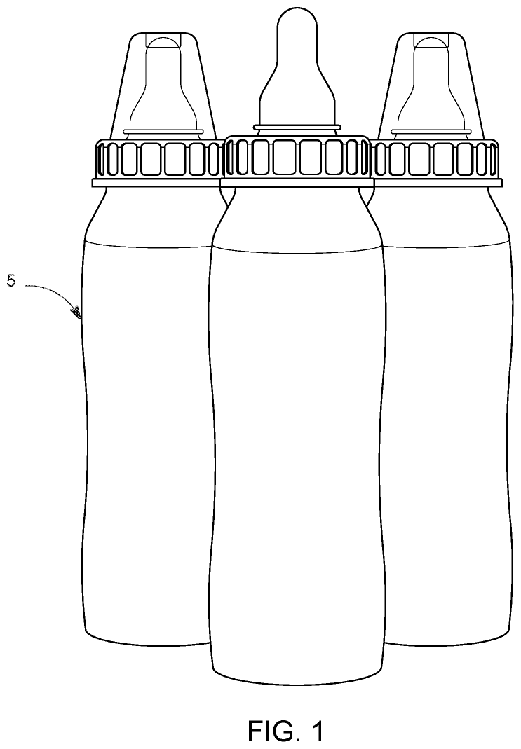

FIG. 2 shows a perspective view of the color changing sippy cup.

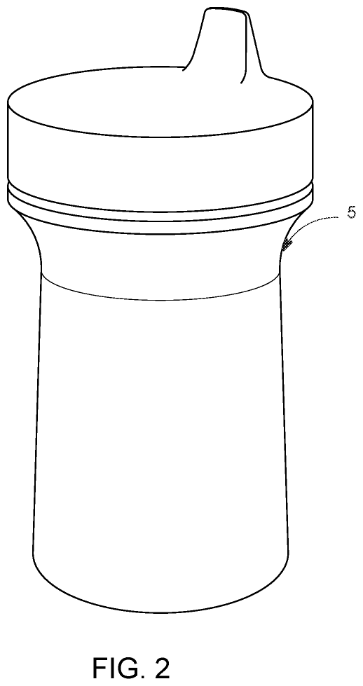

1. A color changing sippy cup or bottle comprising of a thermochromic material.

2. The color changing sippy cup or bottle comprising of the thermochromic material as in claim 1, wherein the sippy cup or bottle changes color when the liquid inside is “too hot”.

3. The color changing sippy cup or bottle comprising of the thermochromic material as in claim 1, wherein the sippy cup or bottle changes color when the liquid inside is “too cold”.

4. The color changing sippy cup or bottle comprising of the thermochromic material as in claim 1, wherein the color change acts as a visual cue for the child to understand when their drink is ready to be sipped.

5. A method of manufacturing a color changing sippy cup or bottle comprising of a thermochromic material.

6. The method of manufacturing a color changing sippy cup or bottle comprising of the thermochromic material as in claim 5, wherein the sippy cup or bottle changes color when the liquid inside is “too hot”.

7. The method of manufacturing a color changing sippy cup or bottle comprising of the thermochromic material as in claim 5, wherein the sippy cup or bottle changes color when the liquid inside is “too cold”.

8. The method of manufacturing a color changing sippy cup or bottle comprising of the thermochromic material as in claim 5, wherein the color change acts as a visual cue for the child to understand when their drink is ready to be sipped.
